(19) United States
(12) Patent Application Publication
(10) Pub. No.: US 2011/0035878 A1
(43) Pub. Date: Feb. 17, 2011

(54) EXERCISE MAT

(76) Inventor: Kathleen Rouse, Atlanta, GA (US)

Correspondence Address: WOLF GREENFIELD & SACKS, P.C., 600 ATLANTIC AVENUE, BOSTON, MA, 02210-2206, US

(21) Appl. No.: 12/854,232

(22) Filed: Aug. 11, 2010

Related U.S. Application Data
(60) Provisional application No. 61/232,833, filed on Aug. 11, 2009.

(51) Int. Cl. A47G 9/06; B05D 5/00

(52) U.S. Cl. 5/417; 427/286

(57) ABSTRACT

An exercise mat is provided which includes a flexible sheet of plastic foam where at least a portion of a top surface of the flexible sheet includes a thermochromic ink. The thermochromic ink provides a visual indication of where a user was positioned on the flexible sheet after the user is no longer positioned on the flexible sheet.

This application claims the benefit of U.S. Provisional application 61/232,833, filed Aug. 11, 2009, which is hereby incorporated by reference in its entirety.

### FIELD OF THE INVENTION

The present invention relates to an exercise mat, such as a yoga mat, made with a thermochromic material.

### BACKGROUND OF THE INVENTION

Exercise mats exist for a variety of activities, such as, but not limited to yoga, pilates, wrestling, stretching and gymnastics. The mat is typically made from a flexible sheet of a plastic foam material.

### SUMMARY OF INVENTION

In one aspect of the invention, an exercise mat includes a flexible sheet of plastic foam where at least a portion of a top surface of the flexible sheet includes a thermochromic ink. The thermochromic ink provides a visual indication of where a user was positioned on the flexible sheet after the user is no longer positioned on the flexible sheet.

In another aspect, an exercise mat includes a flexible sheet of plastic foam where at least a portion of the top surface of the flexible sheet includes a thermochromic material. When the temperature of the portion of the top surface increases, the color changes to provide a visual indication of where a user was positioned on the flexible sheet after the user is no longer positioned on the flexible sheet.

In yet another aspect, a method of making an exercise mat is provided which includes providing a flexible sheet of plastic foam and applying a thermochromic ink to at least a portion of a top surface of the flexible sheet. The thermochromic ink provides a visual indication of where a user was positioned on the flexible sheet after the user is no longer positioned on the flexible sheet.

In another aspect, an exercise mat is provided and includes a flexible sheet of plastic foam with a material covering at least a portion of the top surface of the flexible sheet. The material extends in a plurality of spaced apart linear segments from a first end of the flexible sheet to a second end of the flexible sheet, and the linear segments are arranged to assist in the alignment of a user's body into a yoga position.

Various embodiments of the present invention provide certain advantages. Not all embodiments of the invention share the same advantages and those that do may not share them under all circumstances.

Further features and advantages of the present invention, as well as the structure of various embodiments that incorporate aspects of the invention are described in detail below with reference to the accompanying drawings.

### BRIEF DESCRIPTION OF DRAWINGS

The foregoing and other objects and advantages of the invention will be appreciated more fully from the following drawings, wherein like reference characters designate like features, in which:

FIG. 1 is a perspective view of one embodiment of an exercise mat constructed and arranged for use as a yoga mat;

FIG. 2 is a top view of the yoga mat illustrated in FIG. 1 after a user is no longer positioned on the mat;

FIG. 3 is a perspective view of another embodiment of an exercise mat; and

FIG. 4 is a perspective view of yet another embodiment of an exercise mat.

### DETAILED DESCRIPTION

Aspects of the present invention are directed to an exercise mat configured to provide a visual indication of where a user was positioned on the exercise mat after the user is no longer positioned on the mat. In this respect, a user may be able to readily determine whether she was in a proper position on the mat.

Applicant recognized that proper weight distribution during a variety of activities, such as yoga, is an important aspect of the activity. Applicant also recognized that failure to properly distribute weight in a position, such as a yoga pose, may cause unnecessary pressure on certain joints, which may cause stress and/or lead to an injury.

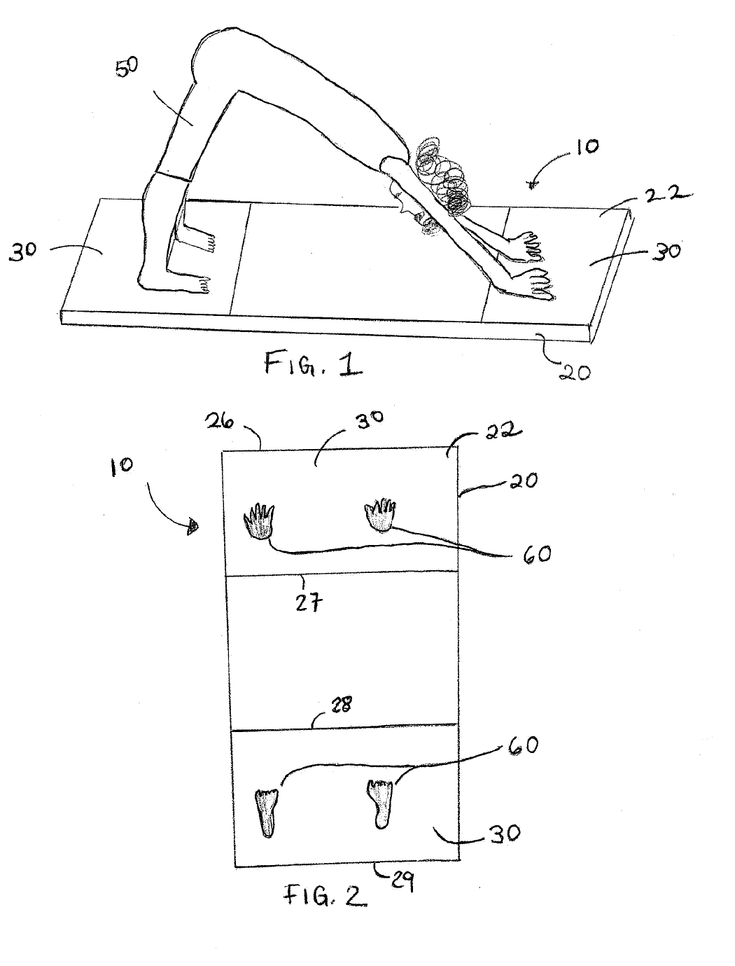

For example, it may be important for a user to flatten out her hands when in a yoga pose such as “downward dog” (shown in FIG. 1) or “upward facing dog”. For certain poses, it may be important for a user to distribute her weight across the six points of the feet:
1.) Big toe to ball of left foot;
2.) Little toe to ball of left foot;
3.) Heel of left foot;
4.) Big toe to ball of right foot;
5.) Little toe to ball of right foot;
6.) Heel of right foot;

Applicant recognized that prior exercise mats do not enable a user to be able to determine weight distribution. Thus, aspects of the present invention are directed to an exercise mat that assists a user in determining whether she is applying the correct weight distribution during different poses.

According to one embodiment, the exercise mat has a thermochromic material. A thermochromic material is a material that changes color based upon a change in temperature. A thermochromic material may cover at least a portion of the exercise mat and it may be configured to change color based upon a user's body heat. In one embodiment, the thermochromic material is configured to change color based upon heat. In another embodiment, the thermochromic material is configured to change color based upon the combination of heat and pressure. Thus, the area of the mat where the user is positioned may change from a first color to a second color. When the user repositions or steps off the mat, the second color remains to provide a visual indication of where the user was positioned. As the mat returns to its initial temperature, the second color fades back into the first color. As discussed in greater detail below, in one embodiment, a thermochromic ink is employed.

Turning to FIGS. 1-2, one embodiment of an exercise mat 10 will now be discussed in greater detail. The exercise mat 10 includes a flexible sheet 20 formed of a plastic foam material. In this particular embodiment, the mat 10 is configured for use as a yoga mat. In FIG. 1, a user 50 is positioned on the top surface 22 of the mat 20 in a yoga pose known as “downward dog”. At least a portion 30 of the top surface 22 of the flexible mat 20 includes a thermochromic material. As shown in FIG. 1, the thermochromic portion 30 extends across a section of the exercise mat that contacts one or both of the user's hands and feet when the user is in this yoga pose. In the embodiment shown in FIG. 1, the thermochromic portion 30 extends across a plurality of spaced apart sections of the mat where a first portion is positioned to contact the user's hands and a second spaced apart portion is configured to contact the user's feet in this particular yoga pose. As shown in FIG. 2, when the user is no longer positioned on the mat 10, the thermochromic material provides a visual indication 60 of where the user was positioned on the flexible sheet. The visual indication of where the user was positioned will indicate the user's weight distribution while in a particular pose. In this particular embodiment, the visual indication 60 is shaped like the user's hands and feet. It should be appreciated that the shape of the visual indication 60 may be different based upon the user's position on the mat.

As mentioned above, the color of a thermochromic material changes based upon temperature (body heat). Thus, the thermochromic portion 30 of the mat 10 changes from a first color to a second color in the areas where a user places her feet and hands. It should be appreciated that in one embodiment, the first or initial color of the thermochromic may be the same as the color or the flexible sheet 20. In another embodiment, the initial color of the thermochromic portion 30 may differ from the color of the flexible sheet 20, as the invention is not so limited.

The placement of the thermochromic material on the flexible sheet 20 may vary, as the invention is not limited in this respect. In one embodiment, the thermochromic material covers the entire top surface 22 of the flexible sheet 24. In another embodiment, the thermochromic material may extend over a smaller portion of the flexible sheet. For example, as shown in FIGS. 1-2, in one embodiment, the thermochromic material extends along a plurality of spaced apart segments 30 extending from the first end 26 to the second end 29 of the sheet 24. In this particular embodiment, the thermochromic material is positioned at both ends of the sheet 24 with the middle portion of the sheet 24 between line 27 and 28 not including thermochromic material. In one embodiment, the thermochromic material covers a majority of the flexible sheet 20.

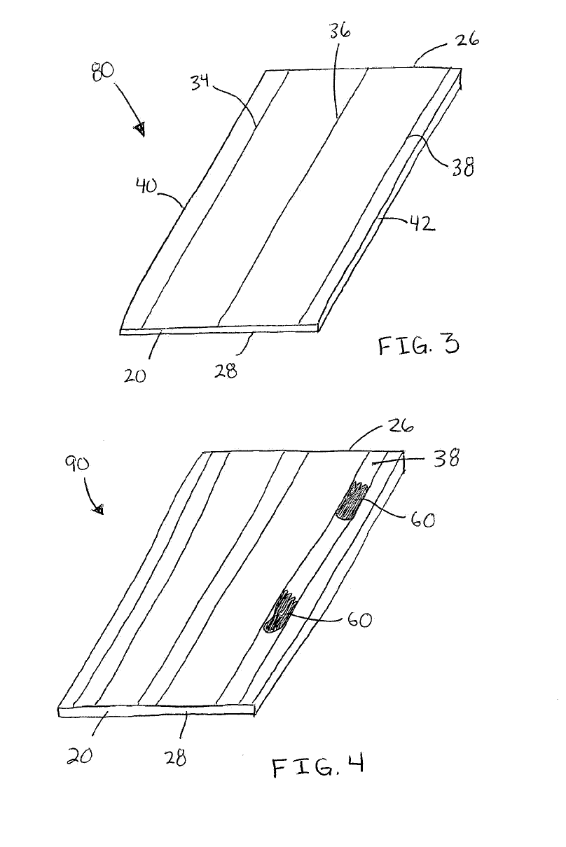

FIG. 3 illustrates another embodiment of an exercise mat 80 which has a plurality of spaced apart linear segments 34, 36, 38 extending from a first end 26 of the flexible sheet 20 to a second end 28 of the flexible sheet. In this embodiment, the linear segments includes a first line 34 extending adjacent a first side 40 of the flexible sheet 20, a second line 36 extending substantially down the center of the flexible sheet, and a third line 38 extending adjacent a second side 42 of the flexible sheet. In this particular embodiment, the thickness of each linear segment may vary from approximately 1 cm-5 cm.

Applicant recognized that an exercise mat having a plurality of linear segments may help to align the user in certain poses. For example, in some poses, such as one known as the “mountain pose” it is important for the user's feet to be substantially parallel with each other to ensure that the user's knees and hips are properly aligned. Thus, the exercise mat 80 shown in FIG. 3 may be used to properly align the user in a particular pose. For example, a user may align her left foot with the first line 34 and her right foot with the third line 38. In FIG. 3, the linear segments extend vertically across the mat 80. In another embodiment, the linear segments may extend horizontally or diagonally across the mat.

In one embodiment, the plurality of spaced apart linear segments 34, 36, 38 are formed with a thermochromic material which, as discussed above, provide a visual indication of a user's position. It is also contemplated that in another embodiment, the plurality of linear segments 34, 36, 38 may be formed of other materials that do not change color, as the invention is not so limited.

FIG. 4 illustrates another embodiment of an exercise mat 90 with a thermochromic material extending in a plurality of spaced apart linear segments 34, 36, 38. In this embodiment, each linear segment 34, 36, 38 has a thickness that is greater in comparison to the embodiment illustrated in FIG. 3. In this particular embodiment, each linear segment may vary from approximately 2 cm-20 cm.

FIG. 4 further illustrates an exercise mat 90 just after a user was positioned on the mat 90. A linear segment 38 formed of a thermochromic material has a visual indication 60 that illustrates the position of a user's feet on the linear segment 38. In some yoga poses, such as one known as the “triangle pose”, both feet are on the ground and the heel of one foot is aligned with the arch of the other foot. For this pose, the user may align her feet along one of the liner segments 34, 36, 38. A more experienced user may align her feet along the center line segment 36. However, a less experienced user may need to place the mat 90 near a wall to help balance herself. Thus, a less experienced user may align her feet on one of the side line segments 34, 38 to position herself closer to the wall. It should be appreciated that the linear segments 34, 36, 38 may be configured to have the same color or they may have different colors, as the invention is not so limited.

There are a variety of thermochromic materials that are contemplated in the present invention. In one embodiment, thermochromic liquid crystals are used. In another embodiment, thermochromic dyes including leuco dyes are used. The thermochromic material may be in the form of an ink or paint that is applied to the top surface of the exercise mat. When a thermochromic ink is applied to the exercise mat, it is contemplated that aqueous flexographic ink and/or aqueous screen ink may be used. Flexographic ink may be used with a printing process that utilizes a flexible relief plate, whereas screen ink may be used with a screen printing process. In another embodiment, the thermochromic material may be incorporated into the exercise mat, and may for example be mixed into the plastic foam material that forms the flexible sheet.

As previously discussed, the thermochromic material changes from a first color to a second color based upon a change in temperature. The second color may remain until the temperature returns to its initial starting temperature. This allows the user or an instructor to analyze the shape and location of the second color to assess whether the user was in the proper position and/or whether the user was properly distributing her weight while in the pose. In one embodiment, the second color remains on the exercise mat for at least 10 seconds after the user is no longer positioned on the mat. In another embodiment, the second color remains on the mat for at least 30 seconds or 1 minute after the user is no longer positioned on the mat.

The temperature change needed to cause the thermochromic material to change from a first color to a second color may vary based upon the type of material used. Thermochromic liquid crystals are known to generally be more sensitive to small temperature changes in comparison to thermochromic leuco dyes. In one embodiment, the thermochromic material changes from a first color to a second color based upon a temperature change of at least 1° F. In another embodiment, the thermochromic material changes to the second color based upon a temperature change of at least 3° F., 5° F. or 10° F.

As mentioned above, in one embodiment, the thermochromic material is configured to change color based upon the combination of heat and pressure. This may be well suited for an activity, such as Hatha yoga, that takes place at a typical room temperature.

In another embodiment, the thermochromic material may be configured such that it changes color based upon heat without pressure. Thus, an exercise mat having such a material may begin to change color if placed in a heated room. It is contemplated that in such an embodiment, the thermochromic material be configured to further change color based upon the pressure and heat of a user positioned on the mat, such that a visual indication of the user's position remains on the mat after the user is no longer positioned on the mat. In this respect, the mat may be configured for Bikram yoga, where the temperature of the room is generally at least 105° F.

It is also contemplated that the exercise mat may include a protective layer. The protective layer may extend over the thermochromic material and may prevent abrasion and/or make the mat easier to clean. The protective layer may still allow heat transfer such that the thermochromic layer is still capable of changing from a first color to a second color due to the combination of heat and pressure.

The exercise mat may be formed of a variety of different materials. In one embodiment, the exercise mat is formed of a flexible sheet of plastic foam. The exercise mat may be formed of materials such as, but not limited to rubber, polystyrene (PS), polyvinylchloride (PVC), polyolefin, and Acrylonitrile Butadiene Styrene (ABS). The flexible sheet may be made of either open or closed cell. In one embodiment the mat is formed from closed cell PVC foam.

The size and thickness of the flexible sheet may vary based on its end use application, as the present invention is not limited in this respect. For example, in one embodiment, the substrate is rectangular extending approximately 3-7 feet in length, and 2-3 feet wide, with a thickness of approximately ⅛-1 inch. The above sizes may be applicable when the substrate is used as a mat for yoga, pilates, stretching, floor mats, etc. In one embodiment, the substrate is sized similar to a standard yoga mat having a width of approximately 60-70 cm, a length of approximately 180-190 cm, and a thickness of approximately 4-7 mm. In other embodiments, the flexible substrate may be smaller or larger, depending upon its application. For example, in one embodiment, where the flexible substrate is used as a large floor mat, such as a gymnastics mat or a wrestling mat, the substrate may have a length and/or width of approximately 5 feet, 10 feet, 15 feet or 20 feet, or more.

It should be appreciated that various embodiments of the present invention may be formed with one or more of the above-described features. The above aspects and features of the invention may be employed in any suitable combination as the present invention is not limited in this respect. It should also be appreciated that the drawings illustrate various components and features which may be incorporated into various embodiments of the present invention. For simplification, some of the drawings may illustrate more than one optional feature or component. However, the present invention is not limited to the specific embodiments disclosed in the drawings. It should be recognized that the present invention encompasses embodiments which may include only a portion of the components illustrated in any one drawing figure, and/or may also encompass embodiments combining components illustrated in multiple different drawing figures.

It should be understood that the foregoing description of various embodiments of the invention are intended merely to be illustrative thereof and that other embodiments, modifications, and equivalents of the invention are within the scope of the invention recited in the claims appended hereto.

What is claimed is:

1. An exercise mat, comprising:
a flexible sheet of plastic foam having a top surface and a bottom surface; and
wherein at least a portion of the top surface of the flexible sheet includes a thermochromic ink to provide a visual indication of where a user was positioned on the flexible sheet after the user is no longer positioned on the flexible sheet.

2. The exercise mat of claim 1, wherein the thermochromic ink covers the entire top surface of the flexible sheet.

3. The exercise mat of claim 1, wherein the thermochromic ink extends in a plurality of spaced apart segments on the flexible sheet.

4. The exercise mat of claim 1, wherein the thermochromic ink extends in a plurality of spaced apart linear segments from a first end of the flexible sheet to a second end of the flexible sheet.

5. The exercise mat of claim 4, wherein the plurality of spaced apart linear segments includes a first line extending adjacent a first side of the flexible sheet, a second line extending substantially down the center of the flexible sheet, and a third line extending adjacent a second side of the flexible sheet.

6. The exercise mat of claim 1, wherein the exercise mat is constructed and arranged for use as a yoga mat.

7. The exercise mat of claim 1, wherein the flexible sheet is closed cell PVC foam.

8. The exercise mat of claim 1, further comprising a protective layer covering the thermochromic material.

9. An exercise mat, comprising:
a flexible sheet of plastic foam having a top surface and a bottom surface; and
wherein at least a portion of the top surface of the flexible sheet includes a thermochromic material such that when the temperature of the portion of the top surface increases, the color changes to provide a visual indication of where a user was positioned on the flexible sheet after the user is no longer positioned on the flexible sheet.

10. The exercise mat of claim 9, wherein the thermochromic material is an ink.

11. The exercise mat of claim 9, wherein the exercise mat is constructed and arranged for use as a yoga mat.

12. A method of making an exercise mat, the method comprising the steps of:
providing a flexible sheet of plastic foam; and
applying a thermochromic ink to at least a portion of a top surface of the flexible sheet to provide a visual indication of where a user was positioned on the flexible sheet after the user is no longer positioned on the flexible sheet.

13. The method of claim 12, wherein the thermochromic ink is applied to the entire top surface of the flexible sheet.

14. The method of claim 12, wherein the thermochromic ink is applied to the flexible sheet in a plurality of spaced apart linear segments extending from a first end of the flexible sheet to a second end of the flexible sheet.

15. An exercise mat, comprising:
a flexible sheet of plastic foam having a top surface and a bottom surface; and
a material covering at least a portion of the top surface of the flexible sheet, the material extending in a plurality of spaced apart linear segments from a first end of the flexible sheet to a second end of the flexible sheet, wherein the linear segments are constructed and arranged to assist in the alignment of a user's body into a yoga position.

16. The exercise mat of claim 15, wherein the plurality of spaced apart linear segments includes a first line extending adjacent a first side of the flexible sheet, a second line extending substantially down the center of the flexible sheet, and a third line extending adjacent a second side of the flexible sheet.

17. The exercise mat of claim 15, wherein the material is a thermochromic ink that provides a visual indication of where a user was positioned on the flexible sheet after the user is no longer positioned on the flexible sheet.
